(19) United States
(12) Patent Application Publication
(10) Pub. No.: US 2025/0168575 A1
(43) Pub. Date: May 22, 2025

(54) HEARING AID HAVING A SOFTWARE VENT

(71) Applicant: Oticon A/S, Smørum (DK)

(72) Inventors: Jan PETERSEN, Smørum (DK); Torsten Kjær SØRENSEN, Smørum (DK)

(21) Appl. No.: 18/940,887

(22) Filed: Nov. 8, 2024

(30) Foreign Application Priority Data
Nov. 16, 2023 (EP) 23210314.3

(51) Int. Cl. H04R 25/00

(52) U.S. Cl. CPC H04R 25/50; H04R 25/40; H04R 25/48

(57) ABSTRACT

Disclosed herein are embodiments of a hearing aid having a first processing path and a second processing path. The different processing paths can have different latencies, allowing for different processing actions to take place. Further, the hearing aid includes a physical vent for providing fluid communication between sides of the in-ear component of the hearing aid.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids. In particular, disclosed herein are embodiments of hearing aids having a software vent to supplement a traditional physical vent.

### SUMMARY

A hearing aid:

In an aspect of the present application, a hearing aid is provided. The hearing aid includes an input unit. The input unit is configured to receive an audible sound. The input unit can be configured to convert the audible sound into an electronic signal representing the audible sound. The hearing aid includes a processing unit. The processing unit is configured to receive the electronic signal. The processing unit is configured to process the electronic signal in a first path for generation of a first auditory sound. The processing unit is configured to process the electronic signal in a second path for generation of a second auditory sound. The second path has a lower latency than the first path. The hearing aid includes an in-ear component. The in-ear component has an output unit. The output unit is configured to output the first auditory sound and the second auditory sound. The hearing aid includes a physical vent. The physical vent can extend through the in-ear component for providing fluid communication between a first side of the in-ear component and a second side of the in-ear component for providing a direct auditory sound.

Disclosed herein are embodiments of a hearing aid having a software vent (e.g., digital vent, acoustical vent). The software vent can supplement a traditional (e.g., physical) vent. In some embodiments, the software vent can replace a traditional vent. The software vent (also known as the second path herein) can be understood as a parallel pathway for the sound passing through the hearing aid outside of the normal (e.g., existing, first path) processing pathway. The software vent can have a low latency (e.g., low delay) as compared to the normal processing pathway. For example, the software vent can have low latency through the use of simple signal processing. This low latency can provide an open sound to the user and allow for a low comb filter effect. In certain implementations, the software vent can be controllable, allowing for flexibility in use in the hearing aid.

In certain iterations, advantageously the hearing aid user can perceive an open sound (a sensation of openness) in the frequency region where amplification is not necessary. The problem is that to perceive an open sound a transparent sound path is needed for all audible sounds. For the user, limited audible sound bandwidth will reduce the perception of a transparent open sound. For the user, a delayed sound will also reduce the perception of a transparent open sound.

If it were possible, a large physical vent would be used. A large physical vent will not provide limited sound bandwidth. However, because of beneficial hearing instrument features like noise reduction, transient protection, directionality, and hearing loss compensation at low frequencies and at mid frequencies a large physical vent is not possible.

Further, delayed sound occurs because of the sound latency or group delay introduced from domain shifted signal processing in the standard processing pathway (e.g., first path). Specifically, latency is introduced due to moving from time domain to filter band domain and back to time domain again.

For a software vent (the supplement vent, second path) a short delay can be achieved. When using a small physical vent, the hearing aid then now have more responsibility to make the audible frequencies transparent to the original sound picked up by the microphones with as few artifacts as possible for the hearing aid user to perceive an open sound and good sound quality.

Thereby embodiments of an improved hearing aid may be provided. Advantageously, the software-vent will not succumb to leakage of sound out of the ear, in particular the sound in low frequencies, as compared to a normal physical vent. Further, certain example hearing aids can allow for features such as noise reduction, directionality, transient noise reduction etc., to change or switch of the software vent when deemed necessary and thereby increase the effect of the feature. In addition, the software vent can allow for streaming bass performance on par with a small vent. In certain implementations, the combination of a physical vent and a low-latency processing path can be seen as a combined system behaving as a large physical vent without the drawbacks in relation to hearing loss compensation using hearing instruments.

Moreover, advantageously example hearing aids can deliver sound with low latency in the mid to high frequency area and at the same time accommodate for low frequency amplification. Therefore, certain example hearing aids can address hearing losses like reverse slope and cookie bite.

Further, due to the low latency of the software vent, the hearing aid(s) can provide sound with less comb filter effect than a normal vent. With prober amplification in selected frequency areas, this will be even further improved.

Additionally, through the optional use of a separate A/D converter with a higher sampling frequency, it can be possible to add sounds at a higher frequency than the normal processed sound.

In users with sloping hearing losses, there is a need for having a relatively large vent, because the user has a normal or mild hearing loss at low frequencies. This is to provide a sensation of openness in the frequency region where amplification is not needed. However, having a large open vent can have several limitations:
When streaming to the hearing aids the sound in the low frequencies will be leaking out creating a very “thin” sound
Hearing aid features such as noise reduction, directionality, transient protection etc., have limited effect because the direct sound through the vent is not treated by the feature
A traditional vent is only effective in the low frequencies, but hearing loss types like reverse slope and cookie bite need good low frequency amplification because the user has a normal or mild hearing loss at low frequencies and needs a more open sound in the mid to high frequencies.

Due to the delay in the hearing aid, there is comb filter effects when the processed sound is mixed with the direct sound from the vent creating coloration of the sound

The disclosed embodiments of hearing aids can alleviate one or more of the problems discussed above and help users with sloping hearing losses.

The disclosed hearing aids include an input unit configured to receive an audible sound (e.g., noise). The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The disclosed hearing aids include a processing unit (e.g., signal processor, processor, digital signal processor (DSB)). The processing unit is configured to receive the electronic signal and apply one or more processings (e.g., components of the processing unit can modify the electronic signal). The processing unit can include a number of components configured to modify the electronic signal.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The compensation is performed in a first path. In one or more example hearing aids, the first path configured to compensate for a hearing impairment of a user of the hearing aid.

The processing unit is configured to process the electronic signal in a first path (e.g., first sound path) for generation of a first auditory sound. The processing unit is configured to process the electronic signal in a second path (e.g., second sound path) for generation of a second auditory sound. In other words, the processing unit includes two parallel pathways for processing the electronic signal.

As discussed herein a path (e.g., a first path and a second path) can be considered an electronic processing pathway. For example, the first path and the second path can include processing components that can apply one or more effects to the electronic signal. The electronic signal following the first path can be considered a first processed signal. The electronic signal following the second path can be considered a second processed signal. The first processed signal can be converted to the first auditory sound. The second processed signal can be converted into the second auditory sound.

In other words, the processing unit allows for the electronic signal to be processed in two different pathways. The first path and the second path can be considered parallel pathways.

In one or more example hearing aids, the same electronic signal can start at each of the first path and the second path. The first path and the second path may modify the electronic signal in different ways. In one or more example hearing aids, the first path can include more processing components than the second path. The second path can be a “simpler” path than the first path.

For example, the first path can be a full digital hearing aid with frontend chip and main chip. The first path can be generally configured to compensate for hearing loss and/or a hearing impairment. The first path is configured to overcome the hearing loss of a user of the hearing aid. For example, the main task of the first path is to provide the right audibility to the user. The first path can include an amplifier for amplification. Further, the first path can include a compressor as the hearing loss is not a linear, and the compressor can apply appropriate compression. Further, the first path can include noise reduction systems, directionality systems, etc. to clean the electronic signal. The first path can include the user of a filter bank to convert domains of the electronic signal (e.g., from a time domain to frequency domain and back to a time domain). The use of the filter bank can lead to higher latencies.

As an example, the first path can include a frontend with an analog-digital converter, input correction, filter bank analysis, noise reduction, audiological compression with a level estimator, filter bank synthesis, output correction, and a backend digital-analog converter. The analog-digital converter could run at higher sample rate than the digital-analog converter.

In certain implementations, the first path and the second path could share the same input analog-digital converter and then down sample this input to different sample rates when doing the signal processing. The hearing aid could then have separately digital-analog converters later in the paths (one for the first path, one for the second path) when mixing the two paths.

The second path can have, in a simplest form, no components. In some implementations, the second path can have a simple filter e.g., a low pass filter which can be made with very few components. The second path can include a bandpass filter (e.g., a high pass filter and a low pass filter). The second path can optionally include an on/off switch. The switch can be configured turn the second path on and off.

In one or more example hearing aids, the second path can allow for remaining in the time domain compared to moving to frequency domain and back done in the first path. This can greatly reduce the latency of the second path. In certain embodiments, the second path does not convert the domain of the electronic signal. For example, the second path does not include a filterbank.

In one or more example hearing aids, the first path is configured to convert the electronic signal from a time domain to a frequency domain and back to a time domain. In one or more example hearing aids, the second path allows the electronic signal to remain in the time domain.

The second path may be known as a software vent (e.g., a digital vent or an electronic vent). The software vent can be configured to emulate a true acoustic (e.g., physical) vent.

Advantageously, the second path can have a lower latency than the first path. The second path can have a smaller delay than the first path. This can be due to less processing that is applied in the second path as compared to the first path. For example, the first path can change domain from time to time-filter-bank domain and back, which requires processing power. The second path can stay in the time domain, thereby reducing delay.

The hearing aid can further include an in-ear component. The in-ear component can be configured to be inserted partially and/or fully into a user's ear canal. The in-ear component can include an output unit. The output unit can be configured to output the first auditory sound and the second auditory sound.

In other words, the hearing aid may comprise an output unit for providing a stimulus perceived by the user as an acoustic signal (e.g., the first auditory sound and the second auditory sound) based on a processed electric signal. The output unit may output a mixed signal based on the first auditory sound and the second auditory sound. The output unit may comprise a number of electrodes of a cochlear implant (for a CI type hearing aid) or a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid further includes a physical vent (e.g., an acoustic vent). The physical vent can be understood as a third path (e.g., third audio path). The physical vent extends through the in-ear component for providing fluid communication between a first side of the in-ear component and a second side of the in-ear component. The first side of the in-ear component can be generally opposite the second side of the in-ear component.

The physical vent can provide for direct auditory sound (e.g., unprocessed by the hearing aid) to pass through the in-ear component. The physical vent can be, for example, a lumen, pathway, etc. The direct auditory sound can be the audible sound.

The physical vent can allow for air venting effect, which can alleviate pressure and/or moisture.

Typically, the use of a physical vent can cause problems to the user as there is a slight delay between the audio received from the physical vent and that received from a standard hearing aid causing a comb filter effect for the user. However, through the use of the disclosed second path, the comb filter effect can be reduced and/or eliminated. Moreover, the use of the second path can allow for a more “open” feeling to a user due to the lower latency of the second path.

In one or more embodiments of the disclosed hearing aid, the hearing aid can include three different sound paths. The first path is the sound path through the hearing aid for hearing loss compensation and noise reduction. The second path is sound path through the software vent. The second path can function as a controlled band pass filter with adjustable sound path gain. The third path is through the physical vent for dehumidification and pressure release. The physical vent can behave as a low pass filter with characteristics depending on the size of the vent. The second sound path and the third sound path can together create a perceived open sound for the user. The first sound path is used to compensate for the hearing loss.

The first path and the second path can share information to reduce the audible comb filter effect occurring when two equal signals create interference when mixed.

The second sound path can have a less complicated signal processing path to reduce latency and if the hearing aid amplifier supports multiple sample rates for the sound paths, or supports analog sound paths, the frequency bandwidth could be extended for this sound path compared to the first sound path.

The second sound path could have a controllable gain and controllable cutoff frequency configured by control logic from the signal processing running on the second path itself or control logic from the signal processing running on the first sound path.

As mentioned, the second path can have a lower latency than the first path. In one or more example hearing aids, the second path has a latency of 0.3-0.5 ms. In one or more example hearing aids, the second path has a latency of 0.2-0.6 ms In one or more example hearing aids, the first path has a latency of 9 ms. The latency may vary depending on the processing done to the electronic signal in the first path and/or the second path. For example, the latency of the first path could be 1, 2, 3, 4, 5, 6, 7, 8, 9, or 10 ms.

In one or more example hearing aids, the second path can have a latency that is less than 10% of the latency of the second path. In one or more example hearing aids, the second path can have a latency that is less than 5% of the latency of the second path.

In one or more example hearing aids, the second path can have a latency that is similar to the latency of the physical vent. This can provide for better matching between the second path and the physical vent, thereby reducing the comb filter effect. Having low latency in the second path can provide an open sound and to have a low comb filter effect.

The latency of a physical vent is essentially 0. It is merely the speed of sound that defines the latency of the physical vent.

In one or more example hearing aids, the second path comprises a filter configured to control a frequency shape of the electronic signal. A simple filter can be used to keep the latency down. It can be advantageous that the filter is configurable and controllable during fitting and use. The controlling part could be the fitting software of e.g., the hearing aid features.

The filter can be a band pass filter (e.g., both high pass and low pass). The second path can act as a band pass filter. This can allow the second path to supplement for a small physical vent. For example, the second path will contribute at frequencies above the small physical vent with a matching crossover frequency between the physical vent and the second path. The small physical vent in combination with the second path can be configured to emulate a larger physical vent.

The second path can include a separate analog-digital converter. For example, the separate analog-digital converter could be used in the cases where frequencies are above a normal cut-off for the hearing aid.

In one or more example hearing aids, the hearing aid can include a control unit. The control unit can be configured to control one or more aspects of the second path. The control unit can be configured to generate a control signal for operation of the second path.

In one or more example hearing aids, the hearing aid further includes a control unit configured to turn the second path on or off. For example, the control unit can be configured to generate a control signal indicative of the second path being turned on or off. The second path may include an on/off switch, and the control signal can be indicative of the on/off switch being off or being on. The control unit can be configured to generate a control signal indicative of the second path changing (e.g., from off to on or vice versa).

There may be certain situations where it is unnecessary to use the second path. For example, during streaming of the hearing aid, it can be useful to the user for the second path to be off.

Accordingly, it could be advantageous to turn off the second path, thereby saving power in the hearing aid.

In one or more example hearing aids, the hearing aid further includes a control unit configured to, based on the electronic signal and/or a feedback signal, modify the second path. In other words, the control unit can allow for real-time changes to the second path depending on the sound environment.

For example, modifying the second path can include applying bandpass filtering with selectable cutoff frequencies and level gain changes. Modifying the second path can include changing the cutoff frequencies and/or the level gain changes.

In certain embodiments, modifying the second path can include complex filtering to reduce comb filter effects. Modifying the second path can depend on the prescribed acoustics by the audiologists to mimic the true acoustics for a larger vent. The bandpass filter of the second path can supplement the physically prescribed venting size. This means that the cutoff frequencies and/or shape from the bandpass filter can be modified in the second path to extend the shape of the physical vent. When dealing with noise reduction, modifying the second path can include adjusting the level of the second path and/or the frequency range of the bandpass filter. Information about the specific type of hearing loss could also be used to shape the overall frequency response of the second sound path via modifying the second path.

For example, when streaming via the hearing aid, modifying the second path can include turning the second path off to provide better bass. In embodiments where the feedback system detects howling, modifying the second path can include switching off and/or attenuation and/or applying a notch filter around a frequency area where the howling is detected.

In noisy environments, modifying the second path can include switching off and/or attenuating the second path to improve the condition for the noise reduction system and directional system.

When a transient noise reduction system of the hearing aid detects a transient, modifying the secondary path can include switching off the secondary path to improve the possibilities to attenuate the transient.

The feedback signal can be a signal received by the hearing aid indicative of feedback that a user would receive. It can be advantageous to lower the feedback indicated by the feedback signal. Therefore, if there is high feedback, as indicated by the feedback signal, the control unit can modify the second path to reduce said feedback.

For example, the second path can include a controllable filter. The controllable filter can be configured to modify the electronic signal to control a shape of the secondary auditory sound. The control unit can be configured to generate a control signal indicative of the particular filtering that the controllable filter should apply.

In one or more example hearing aids, the software vent is equivalent to a 0.88 m diameter physical vent with a 19 mm length. In other words, the software vent acts equivalently to a physical vent of a particular dimension. The dimensional equivalent can vary.

For the use case where sound is streamed to the hearing aid. It is advantageous that the hearing aid user perceives the best sound quality as possible by being transparent to the original streamed content. For a large physical vent, it is difficult to reproduce the low frequency and mid frequency content because of limited speaker sound intensity and leak through the physical vent. Therefore, a small physical vent is advantageous.

In one or more example hearing aids, the second path does not include a filter bank, a noise reduction system, and a hearing loss compensation system. For example, the first path can include the filter bank, the noise reduction system, and the hearing loss compensation system. This allows the second path to have a much lower latency than the first path.

In one or more example hearing aids, the second path only includes a high-pass filter for modification of the electronic signal. The high-pass filter can be a biquad filter. The high-pass filter can be updated by a controlling logic unit that stores different filter coefficients to emulate different acoustic vents.

In one or more example hearing aids, the processing unit is configured to mix the first auditory sound and the second auditory sound for generation of an output sound, wherein the output unit is configured to output the output sound.

For example, the output unit can output two different sounds, namely the first auditory sound and the second auditory sound. Alternatively, or in conjunction, the output unit can output a single sound (e.g., the output sound), which is a mixture of the first auditory sound and the second auditory sound. The processor can include a mixer configured to mix the first auditory sound and the second auditory sound.

In one or more example hearing aids, the electronic signal is at least partially a digital signal. In one or more example hearing aids, the electronic signal is at least partially an analog signal. In one or more example hearing aids, the electronic signal is at least partially a digital signal. In one or more example hearing aids, the electronic signal is at least partially a digital signal and at least partially an analog signal. In one or more example hearing aids, the electronic signal fully a digital signal.

In one or more example hearing aids, the second path is configured to generate the second auditory sound at frequencies of 9.5 KHz and above. In one or more example hearing aids, the second path is configured to generate the auditory sound at frequencies of 9.10-15 KHz. For example, the second path could include an A/D converter separate from the first path. The A/D converter could have a high sampling frequency, such as a sampling frequency of 32 KHz. This can allow for higher frequencies to be achieved by the second path. For an analog solution, even higher frequencies could be used.

In other words, if the hearing aid has an almost closed physical vent, it will act as a low-pass filter, not letting natural high frequency sounds pass. Today the first path can be limited by a sample rate of 20000 Hz (in practice up to 9.5 KHz frequency bandwidth), so the first path will limit the experience (hearing). The second path could have a higher sample rate than the first path, letting higher frequencies than 9.5 KHz pass through (more transparent for the hearing at higher frequencies).

In one or more example hearing aids, notch filters can be used. For example, a notch filter can be in the first path. A notch filter can be in the second path. Notch filters can be in both the first path and the second path. If howling or tendency to howling is detected by the hearing aid, and the frequency at which is happens it is identified, then a notch filter at that frequency can improve on the feedback performance.

In the second path this could be done with biquad filters in parallel as well. In the first path, this could be done in the time-filter-bank domain using other type of signal processing, like envelope processing. A dynamic filter, controllable filter, real-time control, can be a non-static filter design. In practice “dynamic etc.” is updating the filter coefficients for the biquad filters. Controlling the second path from other logics in the first signal path like feedback, noise reduction, transient noise reduction, audiological features, means changing the second biquad filter coefficients or signal amplitude (like mute second path) in real-time (per first signal path frame).

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid (e.g., between the input unit and the output unit). A processing unit (e.g., signal processor) may be located in the forward path (e.g., along the first path and second path). The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

The above-discussion can be applied to headsets as well.

### A Method:

In an aspect, a method of operating a hearing aid is furthermore provided by the present application. The method includes receiving, by an input unit of the hearing aid, an audible sound. The method includes converting, by the input unit, the audible sound into an electronic signal representing the audible sound. The method includes generating, by the processing unit, a first auditory sound via a first processing path based on the electronic signal. The method includes generating, by the processing unit, a second auditory sound via a second processing path based on the electronic signal, wherein the second processing path has a lower latency than the first processing path. The method includes outputting, by an output unit of the hearing aid, the first auditory sound and the second auditory sound.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aids.

### A Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

For example, a tangible computer-readable medium (a data carrier) storing a computer program comprising program code means (instructions) for causing a data processing system (a computer) to perform (carry out) at least some (such as a majority or all) of receiving, by an input unit of the hearing aid, an audible sound, converting, by the input unit, the audible sound into an electronic signal representing the audible sound, generating, by the processing unit, a first auditory sound via a first processing path based on the electronic signal, generating, by the processing unit, a second auditory sound via a second processing path based on the electronic signal, wherein the second processing path has a lower latency than the first processing path, and outputting, by an output unit of the hearing aid, the first auditory sound and the second auditory sound.

### A Computer Program:

A computer program (product) comprising instructions which, when the program is executed by a computer, cause the computer to carry out (steps of) the method described above, in the ‘detailed description of embodiments’ and in the claims is furthermore provided by the present application.

A computer program (product) comprising instructions which, when the program is executed by a computer, cause the computer to carry out (steps of) at least some of receiving, by an input unit of the hearing aid, an audible sound, converting, by the input unit, the audible sound into an electronic signal representing the audible sound, generating, by the processing unit, a first auditory sound via a first processing path based on the electronic signal, generating, by the processing unit, a second auditory sound via a second processing path based on the electronic signal, wherein the second processing path has a lower latency than the first processing path, and outputting, by an output unit of the hearing aid, the first auditory sound and the second auditory sound.

### A Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

A a data processing system comprising a processor and program code means for causing the processor to perform at least some (such as a majority or all) of receiving, by an input unit of the hearing aid, an audible sound, converting, by the input unit, the audible sound into an electronic signal representing the audible sound, generating, by the processing unit, a first auditory sound via a first processing path based on the electronic signal, generating, by the processing unit, a second auditory sound via a second processing path based on the electronic signal, wherein the second processing path has a lower latency than the first processing path, and outputting, by an output unit of the hearing aid, the first auditory sound and the second auditory sound.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows an example schematic of a hearing aid according to the disclosure,

FIG. 2 shows an example schematic of a hearing aid according to the disclosure,

FIG. 3 shows an example schematic of a hearing aid according to the disclosure,

FIG. 4 shows an example of a reverse slope hearing loss problem which can be alleviated by embodiments of a hearing aid according to the disclosure,

FIG. 5 shows an example of a cookie bite hearing loss problem which can be alleviated by embodiments of a hearing aid according to the disclosure, and

FIG. 6 illustrates an example method of operating a hearing aid according to the disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

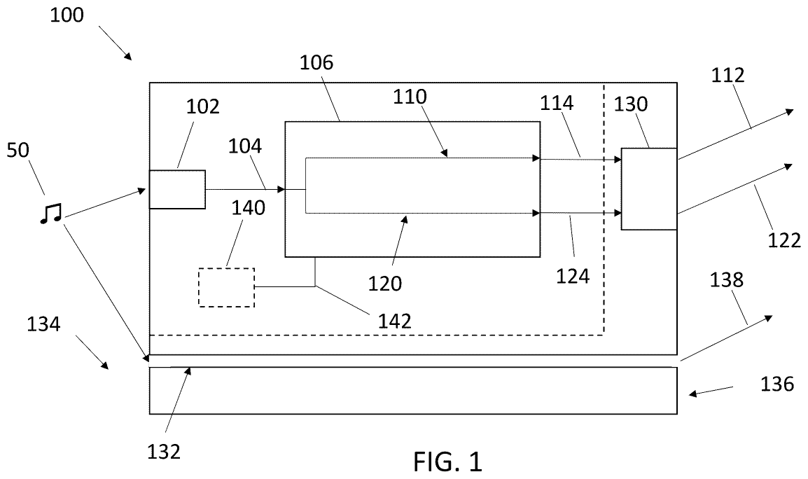

FIG. 1 shows an example schematic of a hearing aid 100 according to the disclosure. The diagram has been simplified for ease of understanding. As shown, the hearing aid includes an input unit 102 configured to receive audible sound 50. The input unit 102 can convert the audible sound 50 into an electronic signal 104 representing the audible sound 50. The electronic signal 104 can be at least partially a digital signal and/or at least partially an analog signal. The electronic signal 104 can be fully a digital signal or fully an analog signal.

The hearing aid 100 further includes a processing unit 106 configured to receive the electronic signal 104. The processing unit 106 is configured to apply one or more processings to the electronic signal 104 for providing an improved audio to a user of the hearing aid 100. In other words, the processing unit 106 can include one or more components to affect the electronic signal 104. These include, for example, filters, time-filter-banks, etc,

As shown, the processing unit 106 is configured to process the electronic signal 104 in a first path 110. The electronic signal 104 processed to the first path 110 can allow for the generation of a first auditory sound 112. For example, the processing unit 106 can process the electronic signal 104 for generation of a first processed signal 114, which can be indicative of the first auditory sound 112.

Further, the processing unit 106 is configured to process the electronic signal 104 in a second path 120. The electronic signal 104 processed to the second path 120 can allow for the generation of a second auditory sound 122. For example, the processing unit 106 can process the electronic signal 104 for generation of a second processed signal 124, which can be indicative of the second auditory sound 122.

Advantageously, the second path 120 can have a lower latency than the first path 110. For example, the second pathway can have a latency of 0.3-0.5 ms while the first path has a latency of 9 ms. The particular latencies may vary depending on the processing components used on the first path and the second path. The second path 120 may not include a filter bank, a noise reduction system, and/or a hearing loss compensation system, allowing for faster processing of the electronic signal 104. The second path 120 may optionally include a filter configured to control a frequency shape of the electronic signal 104. The second path can be configured to generate the second auditory sound 122 at frequencies of 9.5 KHz and above.

The hearing aid 100 further includes an in-ear component having an output unit 130. The output unit 130 is configured to output the first auditory sound 112 and the second auditory sound 122. As shown in FIG. 1, the in-ear component is fully connected within the hearing aid 100. Alternatively, the in-ear component can be in a separate housing and electrically connected to an out-of-ear component (shown by dashed lines in FIG. 1).

As shown, the output unit 130 can separately output the first auditory sound 112 and the second auditory sound 122. In certain examples, the processing unit 106 is configured to mix the first auditory sound 112 and the second auditory sound 122 for generation of an output sound, where the output unit 130 is configured to output the output sound. The processing unit 106 can mix the first electronic signal and the second electronic signal for generation of the output sound.

Further, as shown the hearing aid 100 includes a physical vent 132. The physical vent 132 can extend through the in-ear component for providing fluid communication between a first side 134 of the in-ear component and a second side 136 of the in-ear component for providing a direct auditory sound 138. The direct auditory sound 136 can be the audible sound 50.

The hearing aid 100 can optionally include a control unit 140. The control unit 140 can be configured to generate and/or transmit a control signal 142. As shown, the control unit 140 can provide the control signal 142 to the processing unit 106. The control unit 140 can be configured to turn the second path 120 on or off. The control unit 140 can be configured to, based on the electronic signal 104 and/or a feedback signal, modify the second path 120.

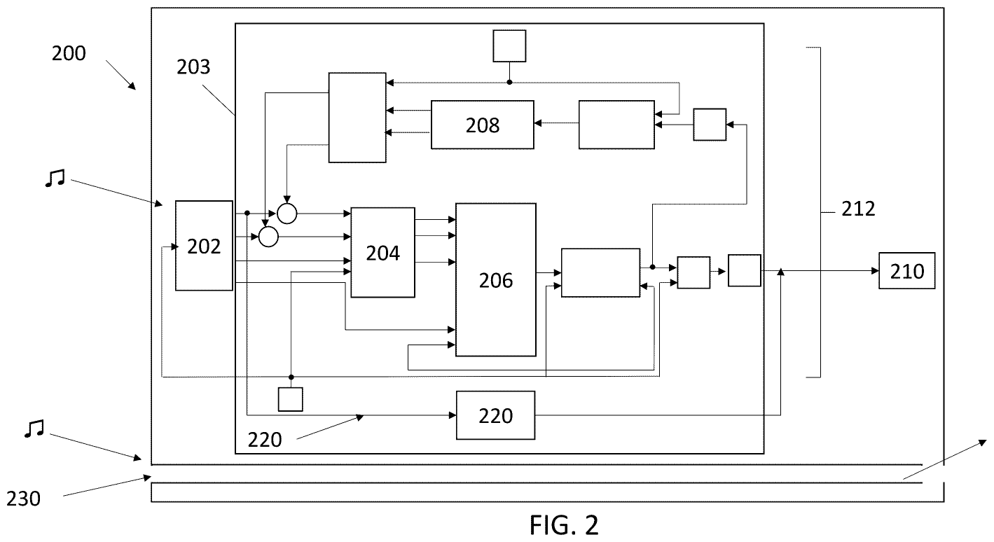

FIG. 2 shows an example schematic of a hearing aid according to the disclosure. The hearing aid 200 illustrates the hearing aid 100 of FIG. 1 with further complexity shown. Not all aspects of hearing aid 200 are shown or discussed with respect to FIG. 2 for convenience.

As shown, the hearing aid 200 includes an input unit 202 configured to receive an audible sound and to convert the audible sound into an electronic signal representing the audible sound.

The hearing aid 200 includes a processing unit 203. The processing unit 203 includes a first path 212 and a second path 220.

As shown, the first path 212 can include a number of components that improve the hearing experience of a user, but also increase latency. For example, the first path 212 can include an amplifier 204, a digital signal processor 206 including a filter bank, as well as feedback controls 208. Further components can be included as well. An output unit 210 can then output a first auditory sound from the first path 212.

As shown in FIG. 2, the second path 220 is substantially simpler than the first path 212. The second path 220 can, for example, contain a filter or switch 220. Otherwise, the electronic signal proceeds to the output unit 210 for outputting of the second auditory sound. This leads to significantly lower latency than the first path 212.

The hearing aid further includes a physical vent 230.

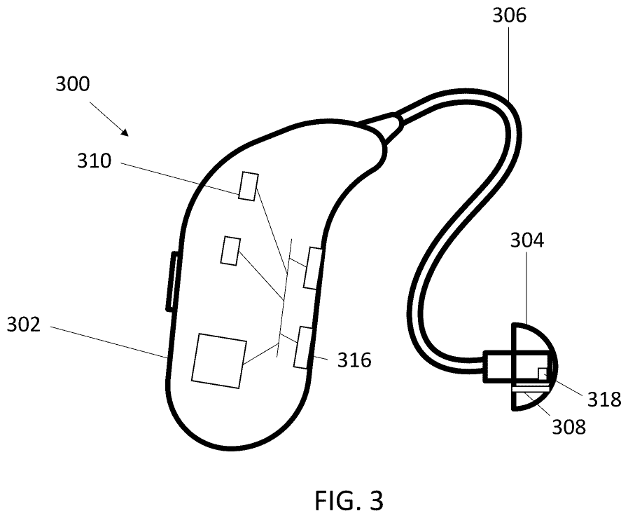

FIG. 3 shows an example schematic of a hearing aid according to the disclosure. As shown, the hearing aid 300 includes a hearing aid housing 314. The hearing aid 300 is configured to be worn behind the user's ears and comprises a behind-the-ear (BTE) part 302 and an in-the-ear component 304. The behind-the-ear part 302 is connected to the in-the-ear component 304 via connecting member 306. However, the hearing aid 300 may be configured in other ways e.g., as completely-in-the-ear hearing aids.

In the embodiment of a hearing aid in FIG. 3, the BTE part 302 comprises an input unit 310 including input transducers (e.g. microphones) for providing an electric signal representative of an audible sound. The input unit further comprises a wireless receiver (or transceivers) for providing directly received auxiliary audio and/or control input signals (and/or allowing transmission of audio and/or control signals to other devices, e.g. to another hearing device, or to a remote control or processing device, or a telephone).

The hearing aid 300 further comprises a processing unit 316, such as configurable signal processor (DSP, e.g. a digital (audio) signal processor), e.g. including a processor for applying a frequency and level dependent gain, e.g. providing hearing loss compensation, beamforming, noise reduction, filter bank functionality, and other digital functionality of a hearing device. The processing unit 316 is configured to process the electronic signal in the first path and the second path discussed herein.

The processing unit 316 is adapted to access the memory. The processing unit 316 is further configured to process one or more of the electric input audio signals and/or one or more of the directly received auxiliary audio input signals, based on a currently selected (activated) hearing aid program/parameter setting (e.g. either automatically selected, e.g. based on one or more sensors, or selected based on inputs from a user interface).

The hearing aid 300 further comprises an output unit 318 (e.g. an output transducer) providing stimuli perceivable by the user as sound based on a processed audio signal from the processor or a signal derived therefrom. The output unit 318 can be in the in-ear component 304 as shown in FIG. 3.

The hearing aid 300, specifically the in-the-ear component 304, can include the physical vent 308 discussed herein. As shown, the physical vent 308 extends through the in-ear component 3104 for providing fluid communication between a first side of the in-ear component 304 and a second side of the in-ear component 304 for providing a direct auditory sound.

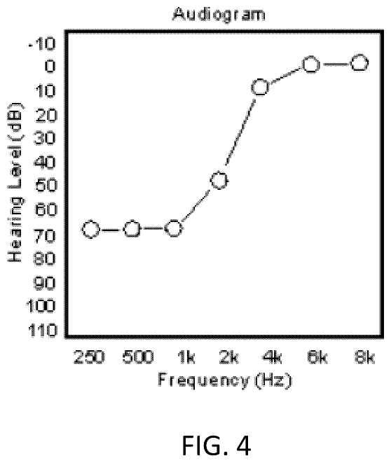

FIG. 4 shows an example of a reverse slope hearing loss problem which can be alleviated by embodiments of a hearing aid according to the disclosure. While a reverse slope hearing loss is not common, users with such a loss are frustrated due to the lack of satisfactory treatment method.

Embodiments of the disclosed hearing aids can help to alleviate a reverse slope hearing loss. With a reverse slope hearing loss problem, gain is needed, and a transparent open sound is wanted in the high frequencies. This is the opposite of what an open dome provides for a normal sloping hearing loss. The disclosed hearing aids can act as a reverse vent, allowing an open sound while also applying gain at the necessary frequencies.

For a “normal” sloping hearing loss, a user wants amplification in the high frequencies but often the user wants an appropriate openness in the low frequencies-hence the physical vent and also this second path.

For a reverse sloping hearing loss it is the opposite. A user wants amplification in the low frequencies and openness in the high frequencies. The first can be obtained with relative closed fitting e.g., a small vent. A closed fitting cannot give an open sensation in the high frequencies. This is what can be obtained with the second path.

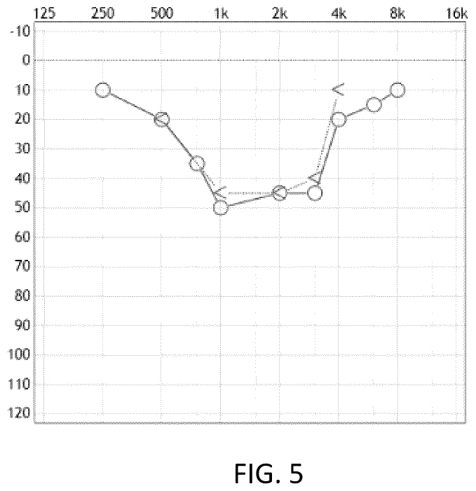

FIG. 5 shows an example of a cookie bite hearing loss problem which can be alleviated by embodiments of a hearing aid according to the disclosure. A cookie bite hearing loss is in the same category as reverse slope discussed with respect to FIG. 4. Similarly, cookie bite hearing losses are not common, but dispensers are frustrated when treating them because lack of satisfactory treatment methods.

Embodiments of the disclosed hearing aids can help alleviate the cookie bite problem. With a cookie bite hearing loss, gain is needed, and a transparent open sound is wanted in the mid to high frequencies. The disclosed hearing aids can provide such a solution.

For a cookie bite, a user has almost the same issues as for a reverse sloping hearing loss. Here a user also wants an open sensation in the high frequencies.

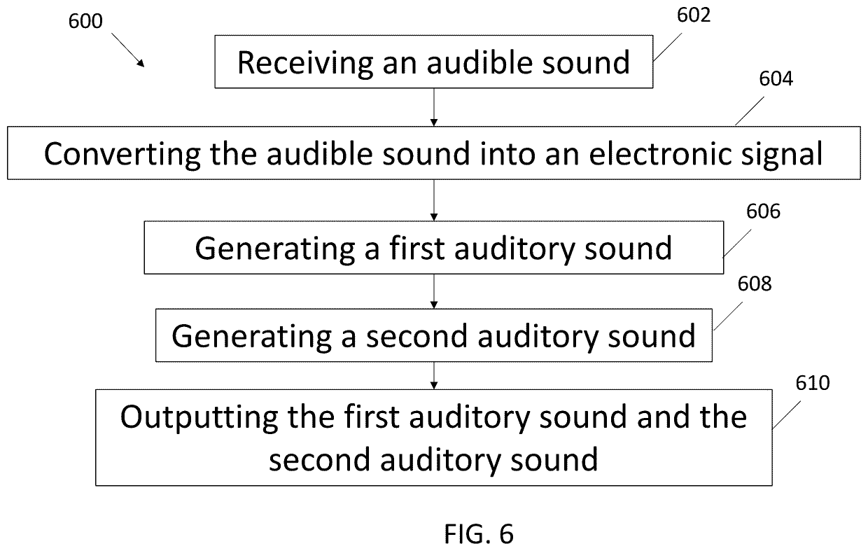

FIG. 6 illustrates an example method of operating a hearing aid according to the disclosure. The method 600 includes receiving 602, by an input unit of the hearing aid, an audible sound. The method 600 includes converting 604, by the input unit, the audible sound into an electronic signal representing the audible sound. The method includes generating 606, by the processing unit, a first auditory sound via a first processing path based on the electronic signal. The method includes generating 608, by the processing unit, a second auditory sound via a second processing path based on the electronic signal, wherein the second processing path has a lower latency than the first processing path. The method 600 includes outputting 610, by an output unit of the hearing aid, the first auditory sound and the second auditory sound.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising:
an input unit configured to receive an audible sound and to convert the audible sound into an electronic signal representing the audible sound;
a processing unit configured to receive the electronic signal, wherein the processing unit is configured to:
process the electronic signal in a first path for generation of a first auditory sound; and
process the electronic signal in a second path for generation of a second auditory sound;
wherein the second path has a lower latency than the first path;
an in-ear component having an output unit configured to output the first auditory sound and the second auditory sound; and
a physical vent extending through the in-ear component for providing fluid communication between a first side of the in-ear component and a second side of the in-ear component for providing a direct auditory sound.

2. Hearing aid of claim 1, wherein the second path has a latency of 0.3-0.5 ms.

3. Hearing aid of claim 1, wherein the first path has a latency of 9 ms.

4. Hearing aid of claim 1, wherein the second path comprises a filter configured to control a frequency shape of the electronic signal.

5. Hearing aid of claim 1, further comprising a control unit configured to turn the second path on or off.

6. Hearing aid of claim 1, further comprising a control unit configured to, based on the electronic signal and/or a feedback signal, modify the second path.

7. Hearing aid of claim 1, wherein the software vent is equivalent to a 0.88 m diameter physical vent with a 19 mm length.

8. Hearing aid of claim 1, wherein the second path does not include a filter bank, a noise reduction system, and a hearing loss compensation system.

9. Hearing aid of claim 1, wherein the processing unit is configured to mix the first auditory sound and the second auditory sound for generation of an output sound, wherein the output unit is configured to output the output sound.

10. Hearing aid of claim 1, the electronic signal is at least partially a digital signal.

11. Hearing aid of claim 1, the electronic signal is at least partially an analog signal.

12. Hearing aid of claim 1, wherein the second path is configured to generate the second auditory sound at frequencies of 9.5 KHz and above.

13. Hearing aid of claim 1, wherein the first path is configured to convert the electronic signal from a time domain to a frequency domain and back to a time domain, and wherein the second path allows the electronic signal to remain in the time domain.

14. Hearing aid of claim 1, wherein the first path configured to compensate for a hearing impairment of a user of the hearing aid.

15. A method of operating a hearing aid, the method comprising:
receiving, by an input unit of the hearing aid, an audible sound;
converting, by the input unit, the audible sound into an electronic signal representing the audible sound;
generating, by the processing unit, a first auditory sound via a first processing path based on the electronic signal;
generating, by the processing unit, a second auditory sound via a second processing path based on the electronic signal, wherein the second processing path has a lower latency than the first processing path; and
outputting, by an output unit of the hearing aid, the first auditory sound and the second auditory sound.
